(19) United States
(12) Patent Application Publication
(10) Pub. No.: US 2026/0208289 A1
(43) Pub. Date: Jul. 23, 2026

(54) Systems and Methods for Improved Laser Manufacturing

(71) Applicant: Nikon Corporation, Tokyo (JP)

(72) Inventors: Takuto Takemoto, Yokohama-shi (JP); Wan Qin, Oro Valley, AZ (US)

(73) Assignee: Nikon Corporation, Tokyo (JP)

(21) Appl. No.: 19/183,769

(22) PCT Filed: Oct. 20, 2023
(86) PCT No.: PCT/US2023/035559

§ 371 Date: Apr. 19, 2025

Related U.S. Application Data
(60) Provisional application No. 63/418,483, filed on Oct. 22, 2022.

(51) Int. Cl. B23K 26/082; B23K 26/0622; B23K 26/064; B29C 64/273; B29C 64/386; B33Y 30/00; B33Y 50/00

(52) U.S. Cl. CPC B23K 26/082; B23K 26/0622; B23K 26/0643; B29C 64/273; B29C 64/386; B33Y 30/00; B33Y 50/00

(57) ABSTRACT

The problem of plasma shielding in pulsed laser manufacturing processes is addressed by systems and methods that break a pulsed laser scan line into subsets of irradiation positions. The subsets are generally offset along the scan line from one another. Within each subset, the irradiation positions are separated from one another by a predetermined separation distance. Thus, the irradiation positions contained in a given subset are interspersed with irradiation positions contained in other subsets. The predetermined separation distance is chosen at least in part to minimize the plasma shielding effect.

### CROSS-REFERENCE

The present application claims priority to U.S. Provisional Patent Application No. 63/418,483, entitled “SYSTEMS AND METHODS FOR IMPROVED LASER MANUFACTURING,” filed on Oct. 22, 2022, which is incorporated herein by reference it its entirety for all purposes.

### BACKGROUND OF THE INVENTION

Lasers are used in a variety of manufacturing processes, such as cutting, welding, drilling, or three-dimensional (3D) printing. In laser manufacturing, quickly scanning a laser along a surface may provide advantages such as increasing the rate at which the laser manufacturing process is performed. For instance, in 3D printing, the laser may be rapidly scanned along a line of metal powder to rapidly heat and melt the powder, which cools to form a line of solid metal. However, prior laser scanning processes may suffer from a number of drawbacks. For instance, pulsed lasers may utilize high-power laser pulses that strike a variety of locations as the pulsed laser is scanned across a metal surface or metal powder. This may result in the formation of a plasma in the vicinity of each location, which can reduce the amount of laser pulse power received by the next location along the scan, due to the so-called “plasma shielding” effect. Such plasma shielding may result in a decrease in the quality of the laser manufacturing process. Accordingly, presented herein are systems and methods for improved laser manufacturing.

### BRIEF DESCRIPTION OF THE DRAWINGS

Various embodiments of the invention are disclosed in the following detailed description and the accompanying drawings.

FIG. 1 shows a schematic depicting a first system for improved pulsed laser manufacturing.

FIG. 2A shows a schematic depicting a first exemplary scan pattern for use with the system described herein with respect to FIG. 1.

FIG. 2B shows a schematic depicting a first exemplary voltage pattern for use with the system described herein with respect to FIG. 1.

FIG. 3A shows a schematic depicting a second exemplary scan pattern for use with the system described herein with respect to FIG. 1.

FIG. 3B shows a schematic depicting a second exemplary voltage pattern for use with the system described herein with respect to FIG. 1.

FIG. 4A shows a schematic depicting a third exemplary scan pattern for use with the system described herein with respect to FIG. 1.

FIG. 4B shows a schematic depicting a third exemplary voltage pattern for use with the system described herein with respect to FIG. 1.

FIG. 5 shows a schematic depicting a second system for improved pulsed laser manufacturing.

FIG. 6 shows a flowchart depicting an exemplary method for improved pulsed laser manufacturing.

FIG. 7 is a block diagram of a computer system used in some embodiments to perform portions of methods for improved pulse laser manufacturing.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term “processor” refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

As used herein, the term “or” shall convey both disjunctive and conjunctive meanings. For instance, the phrase “A or B” shall be interpreted to include element A alone, element B alone, and the combination of elements A and B.

In the Figures, like numbers refer to like elements.

Lasers are used in a variety of manufacturing processes, such as cutting, welding, drilling, or three-dimensional (3D) printing. In laser manufacturing, quickly scanning a laser along a surface may provide advantages such as increasing the rate at which the laser manufacturing process is performed. For instance, in 3D printing, the laser may be rapidly scanned along a line of metal powder to rapidly heat and melt the powder, which cools to form a line of solid metal.

However, prior laser scanning processes may suffer from a number of drawbacks. For instance, pulsed lasers may utilize high-power laser pulses that strike a variety of locations as the pulsed laser is scanned across a metal surface or metal powder. This may result in the formation of a plasma in the vicinity of each location, which can reduce the amount of laser pulse power received by the next location along the scan, due to the so-called “plasma shielding” effect. Such plasma shielding may result in a decrease in the quality of the laser manufacturing process.

Accordingly, the problem of plasma shielding in pulsed laser manufacturing processes is addressed by systems and methods that break a pulsed laser scan line into subsets of irradiation positions. The subsets are generally offset along the scan line from one another. Within each subset, the irradiation positions are separated from one another by a predetermined separation distance. Thus, the irradiation positions contained in a given subset are interspersed with irradiation positions contained in other subsets. The predetermined separation distance is chosen at least in part to minimize the plasma shielding effect.

For each subset, the pulsed laser is scanned along the scan line at a predetermined scan rate, such that laser pulses are directed only at the irradiation positions contained within the subset. Thus, the laser manufacturing operation is performed at the desired irradiation positions without sacrificing manufacturing quality as a result of the plasma shielding effect. By repeating this procedure for all subsets, the laser pulses are directed to all irradiation positions contained in all subsets, thereby completing the laser manufacturing operation along the line.

A system for improved pulsed laser manufacturing is disclosed herein. The system generally comprises: a pulsed laser source configured to emit pulsed laser light; an optical scanner configured to receive the pulsed laser light and to scan the pulsed laser light along a line of a surface, the line comprising a plurality of irradiation positions; and a controller coupled to the optical scanner, the controller configured to: direct the optical scanner to scan the pulsed laser light along the line at a first predetermined scanning rate to a first subset of the plurality of irradiation positions, each irradiation position of the first subset separated from another irradiation position of the first subset by a first predetermined separation distance; and direct the optical scanner to scan the pulsed laser light along the line at a second predetermined scanning rate to a second subset of the plurality of irradiation positions, each irradiation position of the second subset separated from another irradiation position of the second subset by a second predetermined separation distance; wherein the first subset is different from the second subset. In some embodiments, the controller is further configured to direct the optical scanner to apply a first predetermined offset distance between the second subset and the first subset. In some embodiments, each irradiation position of the first subset along the line is different from each irradiation position of the second subset along the line. In some embodiments, the controller is further configured to direct the optical scanner to scan the pulsed laser light along the line at a third predetermined scanning rate to a third subset of the plurality of irradiation positions, each irradiation position of the third subset separated from another irradiation position of the third subset by a third predetermined separation distance; wherein the third subset is different from the first subset and the second subset. In some embodiments, the controller is further configured to direct the optical scanner to apply a second predetermined offset distance between the third subset and the second subset. In some embodiments, the controller is further configured to direct the optical scanner to scan the pulsed laser light along the line at a fourth predetermined scanning rate to a fourth subset of the plurality of irradiation positions, each irradiation position of the fourth subset separated from another irradiation position of the fourth subset by a fourth predetermined separation distance; wherein the fourth subset is different from the first subset, the second subset, and the third subset. In some embodiments, the controller is further configured to direct the optical scanner to apply a third predetermined offset distance between the fourth subset and the third subset. In some embodiments, the optical scanner comprises a galvanometer. In some embodiments, the controller is configured to direct the galvanometer to scan the pulsed laser light along the line at the first, second, third, or fourth predetermined scanning rate by supplying a time-varying voltage to the galvanometer. In some embodiments, the controller is configured to direct the galvanometer to apply the first, second, or third predetermined offset distance by supplying an offset voltage to the galvanometer. In some embodiments, the optical scanner comprises a planar mirror and a rotating polygon mirror. In some embodiments, the controller is configured to direct the rotating polygon mirror to scan the pulsed laser light along the line at the first, second, third, or fourth predetermined scanning rate by supplying a continuous voltage to the rotating polygon mirror. In some embodiments, the controller is configured to direct the planar mirror to apply the first, second, or third predetermined offset distance by rotating the planar mirror. In some embodiments, the pulsed laser light comprises a plurality of laser pulses emitted at a pulse repetition rate and wherein the first, second, third, or fourth predetermined separation distance is determined based upon the first, second, third, or fourth predetermined scanning rate and the pulse repetition rate. In some embodiments, the first, second, third, or fourth predetermined separation distance is chosen such that a pulsed laser light energy delivered to each irradiation position is reduced from a pulsed light energy supplied by the pulsed laser source by no more than 50%. In some embodiments, the first, second, third, or fourth predetermined separation distance is at least about 1 micrometer (μm). In some embodiments, a ratio of the first, second, third, or fourth predetermined separation distance to a diameter of the pulsed laser light is at least about 0.5. In some embodiments, the first, second, third, or fourth predetermined scanning rate is at least about 1 meter per second (m/s).

Further disclosed herein is a method for improved pulsed laser manufacturing. The method generally comprises: using a pulsed laser source to emit pulsed laser light; using an optical scanner to receive the pulsed laser light and to scan the pulsed laser light at a first predetermined scanning rate to a first subset of a plurality of irradiation positions located along a line of a surface, each irradiation position of the first subset separated from another irradiation position of the first subset by a first predetermined separation distance; and using the optical scanner to scan the pulsed laser light along the line at a second predetermined scanning rate to a second subset of the plurality of irradiation positions, each irradiation position of the second subset separated from another irradiation position of the second subset by a second predetermined separation distance; wherein the first subset is different from the second subset. In some embodiments, the method further comprises using the optical scanner to apply a first predetermined offset distance between the second subset and the first subset. In some embodiments, each irradiation position of the first subset along the line is different from each irradiation position of the second subset along the line. In some embodiments, the method further comprises using the optical scanner to scan the pulsed laser light along the line at a third predetermined scanning rate to a third subset of the plurality of irradiation positions, each irradiation position of the third subset separated from another irradiation position of the third subset by a third predetermined separation distance; wherein the third subset is different from the first subset and the second subset. In some embodiments, the method further comprises using the optical scanner to apply a second predetermined offset distance between the third subset and the second subset. In some embodiments, the method further comprises using the optical scanner to scan the pulsed laser light along the line at a fourth predetermined scanning rate to a fourth subset of the plurality of irradiation positions, each irradiation position of the fourth subset separated from another irradiation position of the fourth subset by a fourth predetermined separation distance; wherein the fourth subset is different from the first subset, the second subset, and the third subset. In some embodiments, the method further comprises using the optical scanner to apply a third predetermined offset distance between the fourth subset and the third subset. In some embodiments, the optical scanner comprises a galvanometer. In some embodiments, the method further comprises using the galvanometer to scan the pulsed laser light along the line at the first, second, third, or fourth predetermined scanning rate by supplying a time-varying voltage to the galvanometer. In some embodiments, the method further comprises using the galvanometer to apply the first, second, or third predetermined offset distance by supplying an offset voltage to the galvanometer. In some embodiments, the optical scanner comprises a planar mirror and a rotating polygon mirror. In some embodiments, the method further comprises using the rotating polygon mirror to scan the pulsed laser light along the line at the first, second, third, or fourth predetermined scanning rate by supplying a continuous voltage to the rotating polygon mirror. In some embodiments, the method further comprises using the planar mirror to apply the first, second, or third predetermined offset distance by rotating the planar mirror. In some embodiments, the pulsed laser light comprises a plurality of laser pulses emitted at a pulse repetition rate and wherein the first, second, third, or fourth predetermined separation distance is determined based upon the first, second, third, or fourth predetermined scanning rate and the pulse repetition rate. In some embodiments, the first, second, third, or fourth predetermined separation distance is chosen such that a pulsed laser light energy delivered to each irradiation position is reduced from a pulsed light energy supplied by the pulsed laser by no more than 50% In some embodiments, the first, second, third, or fourth predetermined separation distance is at least about 1 micrometer (μm). In some embodiments, a ratio of the first, second, third, or fourth predetermined separation distance to a diameter of the pulsed laser light is at least about 0.5. In some embodiments, the first, second, third, or fourth predetermined scanning rate is at least about 1 meter per second (m/s).

### Systems for Improved Pulsed Laser Manufacturing

As used herein, the term “pulsed laser manufacturing” refers to any manufacturing process that utilizes pulsed laser operations. Such pulsed laser manufacturing may include, but is not limited to, pulsed laser additive manufacturing, pulsed laser three-dimensional (3D) printing, pulsed laser welding, pulsed laser sintering, pulsed laser annealing, pulsed laser cutting, or pulsed laser drilling.

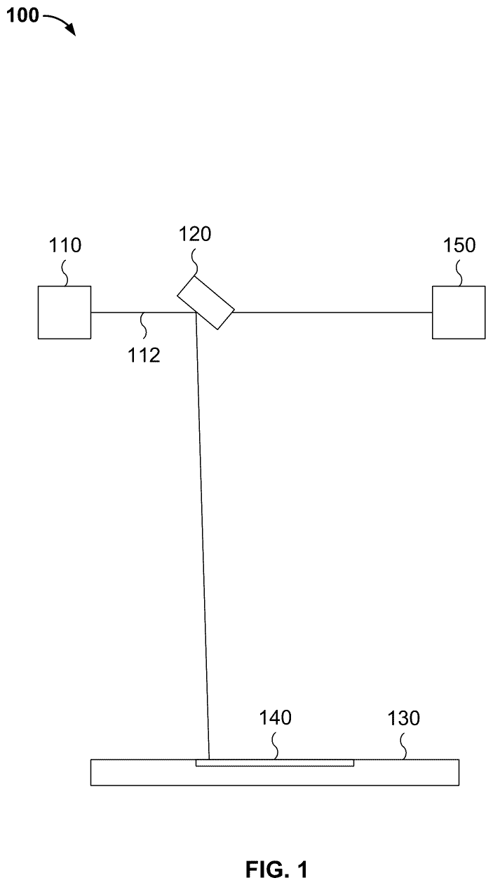

FIG. 1 shows a schematic depicting a system 100 for improved pulsed laser manufacturing. In the example shown, the system 100 comprises a pulsed laser source 110. In some embodiments, the pulsed laser source 110 comprises at least one gas laser, such as at least one nitrogen (N₂) laser or excimer laser. For instance, the pulsed laser source 110 may comprise at least one argon dimer (Ar₂) excimer laser, krypton dimer (Kr₂) excimer laser, fluorine dimer (F₂) excimer laser, xenon dimer (Xe₂) excimer laser, argon fluoride (ArF) excimer laser, krypton chloride (KrCl) excimer laser, krypton fluoride (KrF) excimer laser, xenon bromide (XeBr) excimer laser, xenon chloride (XeCl) excimer laser, or xenon fluoride (XeF) excimer laser. In some embodiments, the pulsed laser source 110 comprises at least one dye laser. In some embodiments, the pulsed laser source 110 comprises at least one metal-vapor laser, such as at least one copper (Cu) metal-vapor laser. In some embodiments, the pulsed laser source 110 comprises at least one solid-state laser, such as at least one ruby laser, metal-doped crystal laser, or metal-doped fiber laser. For instance, the pulsed laser source 110 may comprise at least one neodymium-doped yttrium aluminum garnet (Nd:YAG) laser, neodymium/chromium doped yttrium aluminum garnet (Nd/Cr:YAG) laser, erbium-doped yttrium aluminum garnet (Er:YAG) laser, neodymium-doped yttrium lithium fluoride (Nd:YLF) laser, neodymium-doped yttrium orthovanadate (ND:YVO4) laser, neodymium-doped yttrium calcium oxoborate (Nd:YCOB) laser, neodymium glass (Nd:glass) laser, titanium sapphire (Ti:sapphire) laser, thulium-doped yttrium aluminum garnet (Tm:YAG) laser, ytterbium-doped yttrium aluminum garnet (Yb:YAG) laser, ytterbium-doped glass (Yt:glass) laser, holmium yttrium aluminum garnet (Ho:YAG) laser, chromium-doped zinc selenide (Cr:ZnSe) laser, cerium-doped lithium strontium aluminum fluoride (Ce:LiSAF) laser, cerium-doped lithium calcium aluminum fluoride (Ce:LiCAF) laser, erbium-doped glass (Er:glass) laser, erbium-ytterbium-codoped glass (Er/Yt:glass) laser, uranium-doped calcium fluoride (U:CaF₂) laser, or samarium-doped calcium fluoride (Sm:CaF₂) laser. In some embodiments, the pulsed laser source 110 comprises at least one semiconductor laser or diode laser, such as at least one gallium nitride (GaN) laser, indium gallium nitride (InGaN) laser, aluminum gallium indium phosphide (AlGalInP) laser, aluminum gallium arsenide (AlGaAs) laser, indium gallium arsenic phosphide (InGaAsP) laser, vertical cavity surface emitting laser (VCSEL), or quantum cascade laser. In some embodiments, the pulsed laser source 110 comprises a nanosecond laser light source, a picosecond laser light source, or a femtosecond laser light source.

In some embodiments, the pulsed laser source 110 is configured to emit pulsed laser light 112. In some embodiments, the pulsed laser light 112 is emitted by any pulsed laser source 110 described herein. In some embodiments, the pulsed laser light 112 is produced as a series of laser pulses. In some embodiments, the laser pulses have a peak optical power of at least about 1 watt (W) or more. In some embodiments, the laser pulses have a peak optical power of at most about 1,000 gigawatts (GW) or less. In some embodiments, the laser pulses have a peak optical power that is within a range defined by any two of the preceding values, such as between about 1 W and about 1,000 GW.

In some embodiments, the laser pulses have a pulse length of at least about 1 femtosecond (fs) or more. In some embodiments, the laser pulses have a pulse length of at most about 1,000 microseconds (μs) or less. In some embodiments, the laser pulses have a pulse length that is within a range defined by any two of the preceding values, such as between about 1 fs and about 1,000 μs.

In some embodiments, the laser pulses have a pulse energy of at least about 1 picojoule (pJ) or more. In some embodiments, the laser pulses have a pulse energy of at most about 1,000 microjoules (μJ) or less. In some embodiments, the laser pulses have a pulse energy that is within a range defined by any two of the preceding values, such as between about 1 pJ and about 1,000 μJ.

In some embodiments, the laser pulses have a repetition rate of at least about 1 hertz (Hz) or more. In some embodiments, the laser pulses have a repetition rate of at most about 1,000 kilohertz (kHz) or less. In some embodiments, the laser pulses have a repetition rate that is within a range defined by any two of the preceding values, such as between about 1 H and about 1,000 kHz.

In some embodiments, the laser pulses have a wavelength that is within the ultraviolet (UV), visible, or infrared (IR) portion of the electromagnetic spectrum. In some embodiments, the laser pulses have at least one wavelength of at least about 100 nanometers (nm) or more. In some embodiments, the laser pulses have at least one wavelength of at most about 10 micrometers (μm) or less. In some embodiments, the laser pulses have at least one wavelength that is within a range defined by any two of the preceding values, such as between about 100 nm and about 10 μm.

In the example shown, the system 100 comprises an optical scanner 120. In some embodiments, the optical scanner 120 is configured to receive the pulsed laser light 112. In some embodiments, the optical scanner 120 is configured to direct the pulsed laser light 120 to a surface 130. In some embodiments, the surface 130 comprises a substantially planar surface. In some embodiments, the surface 130 comprises a curved surface. In some embodiments, the surface 130 is configured to have a pulsed laser manufacturing operation performed thereon. In some embodiments, the optical scanner 120 is configured to scan the pulsed laser light 112 along a line 140 of the surface 130. In some embodiments, the line 140 comprises a substantially straight line. In some embodiments, the line 140 comprises a curved line. In some embodiments, the optical scanner 120 comprises a galvanometer.

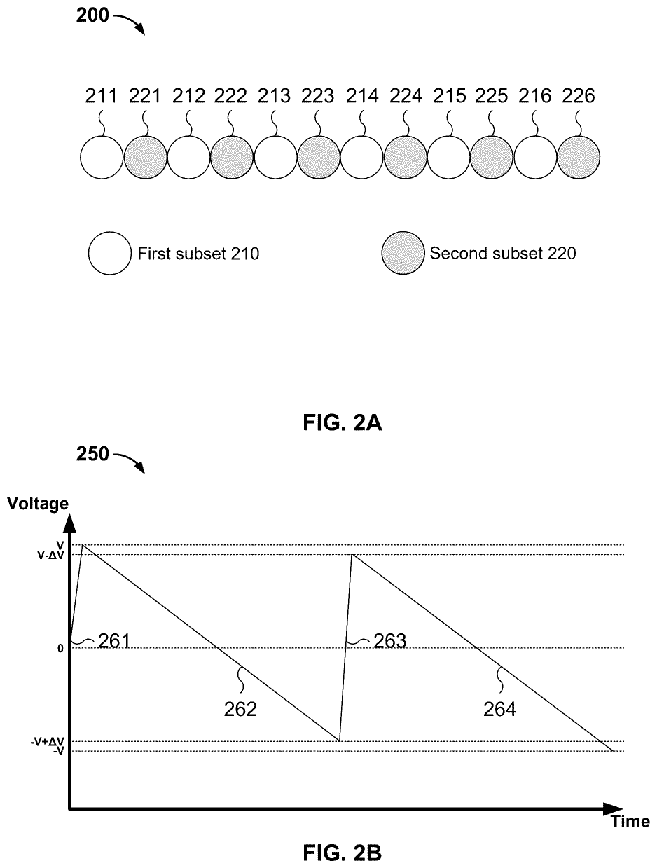

In some embodiments, the system 100 comprises a controller 150. In some embodiments, the controller 150 is coupled to the optical scanner 120. In some embodiments, the controller 150 is configured to direct the optical scanner 120 to scan the pulsed laser light 112 along the line 140 at a plurality of subsets of irradiation positions (not shown in FIG. 1) alone the line 140, as described herein with respect to FIGS. 2-4.

FIG. 2A shows a schematic 200 depicting a first exemplary scan pattern for use with the system 100 described herein with respect to FIG. 1. As shown in FIG. 2A, the line 140 may comprise a plurality of irradiation positions. For example, as shown in FIG. 2A, the line 140 may comprise twelve different irradiation positions. In some embodiments, the line 140 comprises first and second subsets 210 and 220, respectively, of irradiation positions. For example, as shown in FIG. 2A, the first subset 210 may comprise first, second, third, fourth, fifth, and sixth irradiation positions 211, 212, 213, 214, 215, and 216, respectively, and the second subset 220 may comprise seventh, eighth, ninth, tenth, eleventh, and twelfth irradiation positions 221, 222, 223, 224, 225, and 226, respectively. In some embodiments, the first subset 210 and the second subset 220 are different.

In some embodiments, each of the irradiation positions in the first subset 210 is separated from another irradiation position in the first subset 210 by a first predetermined separation distance. For instance, in some embodiments, irradiation position 211 is separated from irradiation position 212 by the first predetermined separation distance, irradiation position 212 is separated from irradiation position 213 by the first predetermined separation distance, and so forth.

In some embodiments, each of the irradiation positions in the second subset 220 is separated from another irradiation position in the second subset 220 by a second predetermined separation distance. For instance, in some embodiments, irradiation position 221 is separated from irradiation position 222 by the second predetermined separation distance, irradiation position 222 is separated from irradiation position 223 by the second predetermined separation distance, and so forth.

In some embodiments, the predetermined separation distance is chosen such that an energy of the pulsed laser light 112 (not shown in FIG. 2A) delivered to each irradiation position on the line 140 is reduced from an energy of the pulsed light 112 supplied by the pulsed laser source 110 (not shown in FIG. 2A) by a predetermined percentage. In some embodiments, the predetermined percentage is at least about 1% or more. In some embodiments, the predetermined percentage is at most about 50% or less. In some embodiments, the predetermined percentage is within a range defined by any two of the preceding values, such as between about 1% and about 50%.

In some embodiments, the first or second predetermined separation distance is at least about 1 μm or more. In some embodiments, the first or second predetermined separation distance is at most about 1,000 μm or less. In some embodiments, the first or second predetermined separation distance is within a range defined by any two of the preceding values, such as between about 1 μm and about 1,000 μm. In some embodiments, the first and second predetermined separation distances are the same. In some embodiments, the first and second predetermined separation distances are different.

In some embodiments, the first or second predetermined separation distance and a diameter of the pulsed laser light 112 (not shown in FIG. 2A) are related by a ratio. In some embodiments, the ratio is at least about 0.5 or more. In some embodiments the ratio is at most about 2.0 or less. In some embodiments, the ratio is within a range defined by any two of the preceding values, such as between about 0.5 and about 2.0.

In some embodiments, the first subset 210 is offset from the second subset 220. For instance, as shown in FIG. 2A, irradiation position 211 is offset from irradiation position 221, irradiation position 212 is offset from irradiation position 222, and so forth. In some embodiments, the first subset 210 is offset from the second subset 220 by a first predetermined offset distance. In some embodiments, the first predetermined offset distance is at least about 1 μm or more. In some embodiments, the first predetermined offset distance is at most about 1,000 μm or less. In some embodiments, the first predetermined offset distance is within a range defined by any two of the preceding values, such as between about 1 μm and about 1,000 μm.

FIG. 2B shows a schematic 250 depicting a first exemplary voltage pattern for use with the system 100 described herein with respect to FIG. 1. In some embodiments, the voltage pattern is utilized to impart the first exemplary scan pattern described herein with respect to FIG. 2A. In some embodiments, the voltage pattern is directed to a galvanometer. In some embodiments, the voltage pattern comprises a first voltage ramp 261, a second voltage ramp 262, a third voltage ramp 263, and a fourth voltage ramp 264.

In some embodiments, during the first voltage ramp 261, the voltage is set to a value V that causes the galvanometer to direct the pulsed laser light to the first irradiation position in the first subset of irradiation positions.

In some embodiments, during the second voltage ramp 262, the voltage is ramped from the initial value V to a final value −V+ΔV. In some embodiments, as the voltage is ramped through the second voltage ramp 262, the galvanometer directs the pulsed laser light along the remaining irradiation positions in the first subset of irradiation positions.

In some embodiments, during the third voltage ramp 263, the voltage is set to a value V−ΔV that causes the galvanometer to direct the pulsed laser light to the first irradiation position in the second subset of irradiation positions. In some embodiments, the offset voltage ΔV sets the first predetermined offset distance between the first subset and the second subset.

In some embodiments, during the fourth voltage ramp 264, the voltage is ramped from the initial value V−ΔV to a final value −V. In some embodiments, as the voltage is ramped through the fourth voltage ramp 264, the galvanometer directs the pulsed laser light along the remaining irradiation positions in the second subset of irradiation positions.

Thus, returning to the description of FIG. 1, in some embodiments, the controller 150 is configured to direct the optical scanner 120 to scan the pulsed laser light 112 along the line 140 to a first subset of the plurality of irradiation positions. In some embodiments, each irradiation position of the first subset is separated from another irradiation position of the first subset by any first predetermined separation distance described herein. In some embodiments, the controller 150 is configured to direct the optical scanner 120 to scan the pulsed laser light 112 along the line 140 to the first subset at a first predetermined scanning rate. In some embodiments, the first predetermined scanning rate is at least about 1 meter per second (m/s) or more. In some embodiments, the first predetermined scanning rate is at most about 10 m/s or less. In some embodiments, the first predetermined scanning rate is within a range defined by any two of the preceding values, such as between about 1 m/s and about 10 m/s.

In some embodiments, the controller 150 is configured to direct the optical scanner 120 to scan the pulsed laser light 112 along the line 140 to a second subset of the plurality of irradiation positions. In some embodiments, each irradiation position of the second subset is separated from another irradiation position of the second subset by any second predetermined separation distance described herein. In some embodiments, the controller 150 is configured to direct the optical scanner 120 to scan the pulsed laser light 112 along the line 140 to the second subset at a second predetermined scanning rate. In some embodiments, the second predetermined scanning rate is any predetermined scanning rate described herein. In some embodiments, the first and second predetermined scanning rates are the same. In some embodiments, the first and second predetermined scanning rates are different.

In some embodiments, the controller 150 is configured to direct the optical scanner 120 to apply the first predetermined offset distance between the second subset and the first subset.

In some embodiments, the controller 150 is configured to direct a galvanometer to scan the pulsed laser light 112 along the line 140 to the first subset and the second subset at the first and second predetermined scanning rates, respectively, by supplying a time-varying voltage to the galvanometer. In some embodiments, the controller 150 is configured to direct the galvanometer to apply the first predetermined offset distance between the second subset and the first subset by supplying an offset voltage to the galvanometer.

In some embodiments, the controller 150 is configured to direct the optical scanner 120 (e.g., the galvanometer) to scan the pulsed laser light to the first subset and the second subset at the first and second predetermined scanning rates, respectively, at least about 1 or more times, at most about 10 times, or a number of times than is within a range defined by any two of the preceding values, such as between about 1 time and about 10 times.

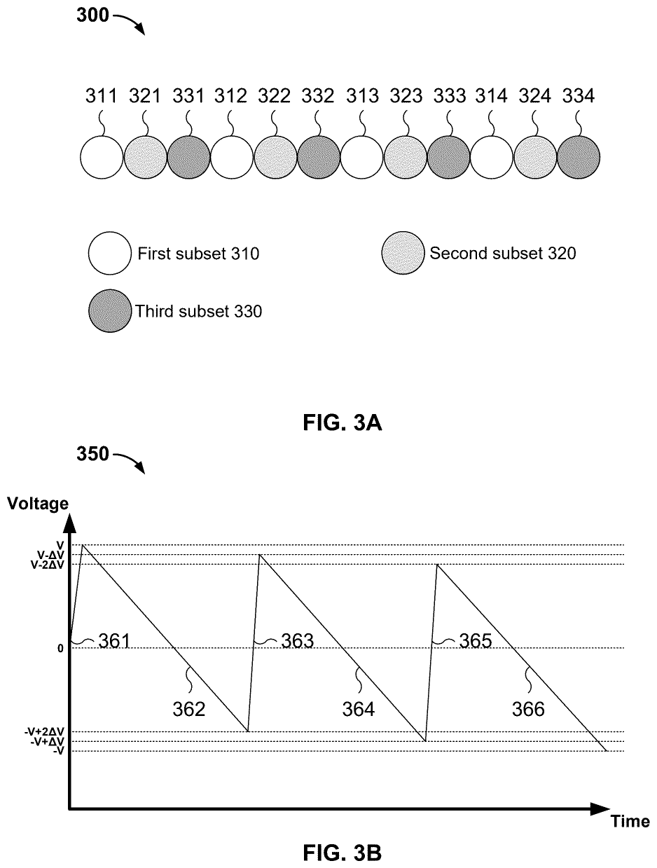

FIG. 3A shows a schematic 300 depicting a second exemplary scan pattern for use with the system 100 described herein with respect to FIG. 1. As shown in FIG. 3A, the line 140 may comprise a plurality of irradiation positions. For example, as shown in FIG. 3A, the line 140 may comprise twelve different irradiation positions. In some embodiments, the line 140 comprises first, second, and third subsets 310, 320, and 330, respectively, of irradiation positions. For example, as shown in FIG. 3A, the first subset 310 may comprise first, second, third, and fourth irradiation positions 311, 312, 313, and 314, respectively, the second subset 320 may comprise fifth, sixth, seventh, and eighth irradiation positions 321, 322, 323, and 324, respectively, and the third subset 330 may comprise ninth, tenth, eleventh, and twelfth irradiation positions 331, 332, 333, and 334, respectively. In some embodiments, the first subset 310, the second subset 320, and the third subset 330 are different.

In some embodiments, each of the irradiation positions in the first subset 310 is separated from another irradiation position in the first subset 310 by any first predetermined separation distance described herein. For instance, in some embodiments, irradiation position 311 is separated from irradiation position 312 by the first predetermined separation distance, irradiation position 312 is separated from irradiation position 313 by the first predetermined separation distance, and so forth.

In some embodiments, each of the irradiation positions in the second subset 320 is separated from another irradiation position in the second subset 320 by any second predetermined separation distance described herein. For instance, in some embodiments, irradiation position 321 is separated from irradiation position 322 by the second predetermined separation distance, irradiation position 322 is separated from irradiation position 323 by the second predetermined separation distance, and so forth.

In some embodiments, each of the irradiation positions in the third subset 330 is separated from another irradiation position in the third subset 330 by a third predetermined separation. In some embodiments, the third predetermined separation distance comprises any predetermined separation distance described herein. For instance, in some embodiments, irradiation position 331 is separated from irradiation position 332 by the third predetermined separation distance, irradiation position 332 is separated from irradiation position 333 by the third predetermined separation distance, and so forth. In some embodiments, the first, second, and third predetermined separation distances are the same. In some embodiments, the first, second, and third predetermined separation distances are different.

In some embodiments, the first subset 310 is offset from the second subset 320. For instance, as shown in FIG. 3A, irradiation position 311 is offset from irradiation position 321, irradiation position 312 is offset from irradiation position 322, and so forth. In some embodiments, the first subset 310 is offset from the second subset 320 by any first predetermined offset distance described herein. In some embodiments, the second subset 320 is offset from the third subset 330. For instance, as shown in FIG. 3A, irradiation position 321 is offset from irradiation position 331, irradiation position 322 is offset from irradiation position 332, and so forth. In some embodiments, the second subset 320 is offset from the third subset 330 by a second predetermined offset distance. In some embodiments, the second predetermined offset distance comprises any predetermined offset distance described herein.

FIG. 3B shows a schematic 350 depicting a second exemplary voltage pattern for use with the system 100 described herein with respect to FIG. 1. In some embodiments, the voltage pattern is utilized to impart the second exemplary scan pattern described herein with respect to FIG. 3A. In some embodiments, the voltage pattern is directed to a galvanometer. In some embodiments, the voltage pattern comprises a first voltage ramp 361, a second voltage ramp 362, a third voltage ramp 363, a fourth voltage ramp 364, a fifth voltage ramp 365, and a sixth voltage ramp 366.

In some embodiments, during the first voltage ramp 361, the voltage is set to a value V that causes the galvanometer to direct the pulsed laser light to the first irradiation position in the first subset of irradiation positions.

In some embodiments, during the second voltage ramp 362, the voltage is ramped from the initial value V to a final value −V+2ΔV. In some embodiments, as the voltage is ramped through the second voltage ramp 362, the galvanometer directs the pulsed laser light along the remaining irradiation positions in the first subset of irradiation positions.

In some embodiments, during the third voltage ramp 363, the voltage is set to a value V−ΔV that causes the galvanometer to direct the pulsed laser light to the first irradiation position in the second subset of irradiation position. In some embodiments, the offset voltage ΔV sets the first predetermined offset distance between the first subset and the second subset.

In some embodiments, during the fourth voltage ramp 364, the voltage is ramped from the initial value V−ΔV to a final value −V+ΔV. In some embodiments, as the voltage is ramped through the fourth voltage ramp 364, the galvanometer directs the pulsed laser light along the remaining irradiation positions in the second subset of irradiation positions.

In some embodiments, during the fifth voltage ramp 365, the voltage is set to a value V−2ΔV that causes the galvanometer to direct the pulsed laser light to the first irradiation position in the third subset of irradiation positions. In some embodiments, the offset voltage ΔV sets the second predetermined offset distance between the second subset and the third subset.

In some embodiments, during the sixth voltage ramp 366, the voltage is ramped from the initial value V−2ΔV to a final value −V. In some embodiments, as the voltage is ramped through the sixth voltage ramp 366, the galvanometer directs the pulsed laser light along the remaining irradiation positions in the third subset of irradiation positions.

Thus, returning to the description of FIG. 1, in some embodiments, the controller 150 is configured to direct the optical scanner 120 to scan the pulsed laser light 112 along the line 140 to a third subset of the plurality of irradiation positions. In some embodiments, each irradiation position of the third subset is separated from another irradiation position of the third subset by any third predetermined separation distance described herein. In some embodiments, the controller 150 is configured to direct the optical scanner 120 to scan the pulsed laser light 112 along the line 140 to the third subset at a third predetermined scanning rate. In some embodiments, the third predetermined scanning rate is any predetermined scanning rate described herein. In some embodiments, the first, second, and third predetermined scanning rates are the same. In some embodiments, the first, second, and third predetermined scanning rates are different.

In some embodiments, the controller 150 is configured to direct the optical scanner 120 to apply the second predetermined offset distance between the third subset and the second subset.

In some embodiments, the controller 150 is configured to direct a galvanometer to scan the pulsed laser light 112 along the line 140 to the first, second, and third subsets at the first, second, and third predetermined scanning rates, respectively, by supplying a time-varying voltage to the galvanometer. In some embodiments, the controller 150 is configured to direct the galvanometer to apply the first predetermined offset distance between the second subset and the first subset, and to apply the second predetermined offset distance between the third subset and the second subset, by supplying an offset voltage to the galvanometer.

In some embodiments, the controller 150 is configured to direct the optical scanner 120 (e.g., the galvanometer) to scan the pulsed laser light to the first, second, and third subsets at the first, second, and third predetermined scanning rates, respectively, at least about 1 or more times, at most about 10 times, or a number of times than is within a range defined by any two of the preceding values, such as between about 1 time and about 10 times.

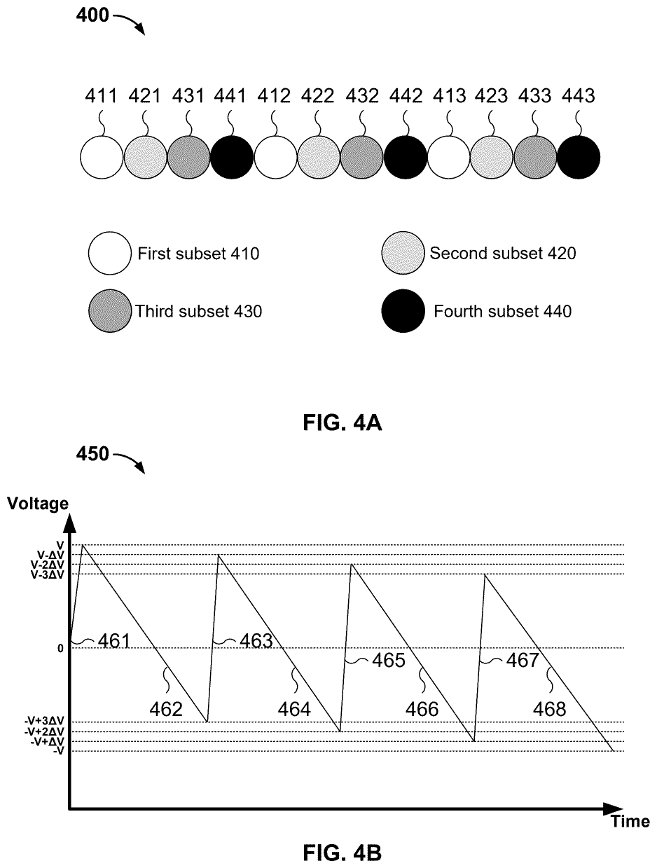

FIG. 4A shows a schematic 400 depicting a third exemplary scan pattern for use with the system 100 described herein with respect to FIG. 1. As shown in FIG. 4A, the line 140 may comprise a plurality of irradiation positions. For example, as shown in FIG. 4A, the line 140 may comprise twelve different irradiation positions. In some embodiments, the line 140 comprises first, second, third, and fourth subsets 410, 420, and 430, and 440, respectively, of irradiation positions. For example, as shown in FIG. 4A, the first subset 410 may comprise first, second, and third irradiation positions 411, 412, and 413, respectively, the second subset 420 may comprise fourth, fifth, and sixth irradiation positions 421, 422, and 423, respectively, the third subset 430 may comprise seventh, eighth, and ninth irradiation positions 431, 432, and 433, respectively, and the fourth subset 440 may comprise tenth, eleventh, and twelfth irradiation positions 441, 442, and 443, respectively. In some embodiments, the first subset 410, the second subset 420, the third subset 430, and the fourth subset 440 are different.

In some embodiments, each of the irradiation positions in the first subset 410 is separated from another irradiation position in the first subset 410 by any first predetermined separation distance described herein. For instance, in some embodiments, irradiation position 411 is separated from irradiation position 412 by the first predetermined separation distance, irradiation position 412 is separated from irradiation position 413 by the first predetermined separation distance, and so forth.

In some embodiments, each of the irradiation positions in the second subset 420 is separated from another irradiation position in the second subset 420 by any second predetermined separation distance described herein. For instance, in some embodiments, irradiation position 421 is separated from irradiation position 422 by the second predetermined separation distance, irradiation position 422 is separated from irradiation position 423 by the second predetermined separation distance, and so forth.

In some embodiments, each of the irradiation positions in the third subset 430 is separated from another irradiation position in the third subset 430 by any third predetermined separation distance described herein. For instance, in some embodiments, irradiation position 431 is separated from irradiation position 432 by the third predetermined separation distance, irradiation position 432 is separated from irradiation position 433 by the third predetermined separation distance, and so forth.

In some embodiments, each of the irradiation positions in the fourth subset 440 is separated from another irradiation position in the fourth subset 440 by a fourth predetermined separation distance. In some embodiments, the fourth predetermined separation distance comprises any predetermined separation distance described herein. For instance, in some embodiments, irradiation position 441 is separated from irradiation position 442 by the fourth predetermined separation distance, irradiation position 442 is separated from irradiation position 443 by the fourth predetermined separation distance, and so forth. In some embodiments, the first, second, third, and fourth predetermined separation distances are the same. In some embodiments, the first, second, third, and fourth predetermined separation distances are different.

In some embodiments, the first subset 410 is offset from the second subset 420. For instance, as shown in FIG. 4A, irradiation position 411 is offset from irradiation position 421, irradiation position 412 is offset from irradiation position 422, and so forth. In some embodiments, the first subset 410 is offset from the second subset 420 by any first predetermined offset distance described herein. In some embodiments, the second subset 420 is offset from the third subset 430. For instance, as shown in FIG. 4A, irradiation position 421 is offset from irradiation position 431, irradiation position 422 is offset from irradiation position 432, and so forth. In some embodiments, the second subset 420 is offset from the third subset 430 by any second predetermined offset distance described herein.

In some embodiments, the third subset 430 is offset from the fourth subset 440. For instance, as shown in FIG. 4A, irradiation position 431 is offset from irradiation position 441, irradiation position 432 is offset from irradiation position 442, and so forth. In some embodiments, the third subset 430 is offset from the fourth subset 440 by a third predetermined offset distance. In some embodiments, the third predetermined offset distance comprises any predetermined offset distance described herein.

FIG. 4B shows a schematic 450 depicting a third exemplary voltage pattern for use with the system 100 described herein with respect to FIG. 1. In some embodiments, the voltage pattern is utilized to impart the third exemplary scan pattern described herein with respect to FIG. 4A. In some embodiments, the voltage pattern is directed to a galvanometer. In some embodiments, the voltage pattern comprises a first voltage ramp 461, a second voltage ramp 462, a third voltage ramp 463, a fourth voltage ramp 464, a fifth voltage ramp 465, a sixth voltage ramp 466, a seventh voltage ramp 467, and an eighth voltage ramp 468.

In some embodiments, during the first voltage ramp 461, the voltage is set to a value V that causes the galvanometer to direct the pulsed laser light to the first irradiation position in the first subset of irradiation positions.

In some embodiments, during the second voltage ramp 462, the voltage is ramped from the initial value V to a final value −V+3ΔV. In some embodiments, as the voltage is ramped through the second voltage ramp 462, the galvanometer directs the pulsed laser light along the remaining irradiation position in the first subset of irradiation position.

In some embodiments, during the third voltage ramp 463, the voltage is set to a value V−ΔV that causes the galvanometer to direct the pulsed laser light to the first irradiation position in the second subset of irradiation position. In some embodiments, the offset voltage ΔV sets the first predetermined offset distance between the first subset and the second subset.

In some embodiments, during the fourth voltage ramp 464, the voltage is ramped from the initial value V−ΔV to a final value −V+2ΔV. In some embodiments, as the voltage is ramped through the fourth voltage ramp 464, the galvanometer directs the pulsed laser light along the remaining irradiation positions in the second subset of irradiation positions.

In some embodiments, during the fifth voltage ramp 465, the voltage is set to a value V−2ΔV that causes the galvanometer to direct the pulsed laser light to the first irradiation position in the third subset of irradiation positions. In some embodiments, the offset voltage ΔV sets the predetermined second offset distance between the second subset and the third subset.

In some embodiments, during the sixth voltage ramp 464, the voltage is ramped from the initial value V−2ΔV to a final value −V+ΔV. In some embodiments, as the voltage is ramped through the sixth voltage ramp 466, the galvanometer directs the pulsed laser light along the remaining irradiation positions in the third subset of irradiation positions.

In some embodiments, during the seventh voltage ramp 467, the voltage is set to a value V−3ΔV that causes the galvanometer to direct the pulsed laser light to the first irradiation position in the fourth subset of irradiation positions. In some embodiments, the offset voltage ΔV sets the third predetermined offset distance between the third subset and the fourth subset.

In some embodiments, during the eighth voltage ramp 468, the voltage is ramped from the initial value V−3ΔV to a final value −V. In some embodiments, as the voltage is ramped through the eighth voltage ramp 468, the galvanometer directs the pulsed laser light along the remaining irradiation positions in the fourth subset of irradiation positions.

Thus, returning to the description of FIG. 1, in some embodiments, the controller 150 is configured to direct the optical scanner 120 to scan the pulsed laser light 112 along the line 140 to a fourth subset of the plurality of irradiation positions. In some embodiments, each irradiation position of the fourth subset is separated from another irradiation position of the fourth subset by any fourth predetermined separation distance described herein. In some embodiments, the controller 150 is configured to direct the optical scanner 120 to scan the pulsed laser light 112 along the line 140 to the fourth subset at a fourth predetermined scanning rate. In some embodiments, the fourth predetermined scanning rate is any predetermined scanning rate described herein. In some embodiments, the first, second, third, and fourth predetermined scanning rates are the same. In some embodiments, the first, second, third, and fourth predetermined scanning rates are different.

In some embodiments, the controller 150 is configured to direct the optical scanner 120 to apply the third predetermined offset distance between the fourth subset and the third subset.

In some embodiments, the controller 150 is configured to direct a galvanometer to scan the pulsed laser light 112 along the line 140 to the first, second, third, and fourth subsets at the first, second, third, and fourth predetermined scanning rates, respectively, by supplying a time-varying voltage to the galvanometer. In some embodiments, the controller 150 is configured to direct the galvanometer to apply the first, second, and third predetermined offset distance between the second subset and the first subset, between the third subset and the second subset, and between the fourth subset and the third subset, respectively, by supplying an offset voltage to the galvanometer.

In some embodiments, the controller 150 is configured to direct the optical scanner 120 (e.g., the galvanometer) to scan the pulsed laser light to the first, second, third, and fourth subsets at the first, second, third, and fourth predetermined scanning rates, respectively at least about 1 or more times, at most about 10 times, or a number of times than is within a range defined by any two of the preceding values, such as between about 1 time and about 10 times.

FIGS. 2A, 3A, and 4A depict each irradiation position as a circle. In the examples shown in FIGS. 2A, 3A, and 4A, each circle represents the full width at half maximum (FWHM) distribution of laser pulse energy. In the examples shown in FIGS. 2A, 3A, and 4A, the circles are depicted as not overlapping one another within the FWHM distribution. However, the disclosure is not intended to be so limiting. In some embodiments, the irradiation positions partially overlap within the FWHM distribution. In some embodiments, the irradiation positions do not overlap within the FWHM distribution.

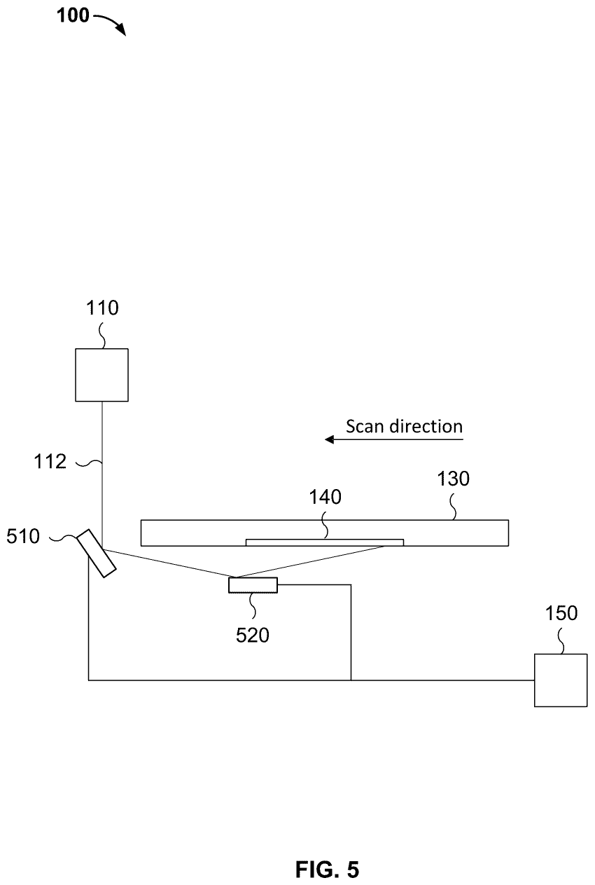

Although FIGS. 2B, 3B, and 4B describe scan patterns that utilize a galvanometer, the disclosure is not intended to be so limiting. For instance, as shown in FIG. 5, in some embodiments, the system 100 described herein with respect to FIG. 1 may utilize an optical scanner 120 comprising a planar mirror 510 and a scanning mirror 520. In some embodiments, the scanning mirror 520 comprises a galvanometer or a rotating polygon mirror. In some embodiments, the controller 150 is configured to direct the scanning mirror 520 to scan the pulsed laser light 112 along the line 140 at the first, second, third, or fourth predetermined scanning rate by supplying a continuous or time-varying voltage to the scanning mirror 520. In some embodiments, the controller 150 is configured to direct the planar mirror 510 to apply the first, second, third, or fourth predetermined offset distance by rotating the planar mirror 510 to a predetermined rotation angle. By altering the predetermined rotation angle of the planar mirror 510, the pulse laser light 112 can be directed to different positions on the line 140, thereby applying different predetermined offset distances.

Although FIGS. 1, 2A, 2B, 3A, 3B, 4A, 4B, and 5 describe the use of 2, 3, or 4 subsets of irradiation positions, the disclosure is not intended to be so limiting. For instance, in some embodiments, the controller 150 is configured to direct the optical scanner 120 to scan the pulsed laser light 112 along the line 140 at fifth, sixth, seventh, eighth, ninth, tenth, or additional predetermined scanning rates (each of which may comprise any predetermined scanning rate described herein) to fifth, sixth, seventh, eighth, ninth, tenth, or additional subsets of the plurality of irradiation positions. In some embodiments, each irradiation position of the fifth, sixth, seventh, eighth, ninth, tenth, or additional subset is separated from another irradiation position of the fifth, sixth, seventh, eighth, ninth, tenth, or additional subset by a fifth, sixth, seventh, eighth ninth tenth, or additional predetermined separation distance, each of which may comprise any predetermined separation distance described herein.

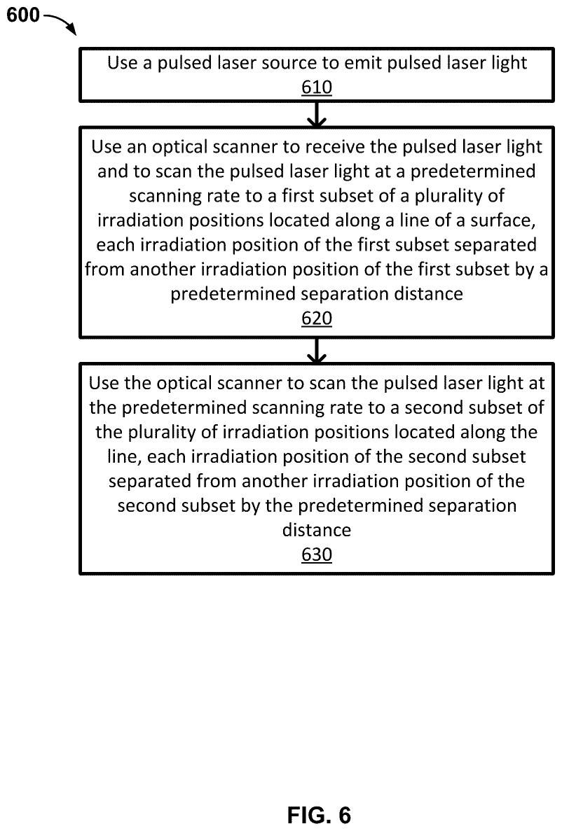

FIG. 6 shows a flowchart depicting an exemplary method 600 for improved pulsed laser manufacturing. In the example shown, a pulsed laser source is used to emit pulsed laser light at 610. In some embodiments, the pulsed laser source comprises any pulsed laser source described herein with respect to FIG. 1. In some embodiments, the pulsed laser light comprises any pulsed laser light described herein with respect to FIG. 1.

In the example shown, an optical scanner is used to receive the pulsed laser light and to scan the pulsed laser light at a first predetermined scanning rate to a first subset of a plurality of irradiation positions along a line of a surface at 620. In some embodiments, the optical scanner comprises any optical scanner described herein with respect to FIG. 1. In some embodiments, the first predetermined scanning rate comprises any first predetermined scanning rate described herein with respect to FIG. 1 or 2A. In some embodiments, the first subset comprises any first subset described herein with respect to FIG. 1 or 2A. In some embodiments, the line comprises any line described herein with respect to FIG. 1. In some embodiments, the surface comprises any surface described herein with respect to FIG. 1. In some embodiments, each irradiation position of the first subset is separated from another irradiation position of the first subset by a first predetermined separation distance, as described herein with respect to FIGS. 1 and 2A. In some embodiments, the first predetermined separation distance comprises any first predetermined separation distance described herein with respect to FIG. 1 or 2A.

In the example shown, the optical scanner is used to receive the pulsed laser light and to scan the pulsed laser light at a second predetermined scanning rate to a second subset of a plurality of irradiation positions along the line at 630. In some embodiments, the second predetermined scanning rate comprises any second predetermined scanning rate described herein with respect to FIG. 2A. In some embodiments, the second subset comprises any second subset described herein with respect to FIG. 1 or 2A. In some embodiments, each irradiation position of the second subset is separated from another irradiation position of the second subset by a second predetermined separation distance, as described herein with respect to FIGS. 1 and 2A. In some embodiments, the optical scanner is used to apply a first predetermined offset distance between the second subset and the first subset, as described herein with respect to FIGS. 1 and 2A. In some embodiments, the first predetermined offset distance comprises any first predetermined offset distance described herein with respect to FIG. 1 or 2A.

In some embodiments, the method 600 further comprises using the optical scanner is used to receive the pulsed laser light and to scan the pulsed laser light at a third predetermined scanning rate to a third subset of a plurality of irradiation positions along the line. In some embodiments, the third predetermined scanning rate comprises any third predetermined scanning rate described herein with respect to FIG. 3A. In some embodiments, the third subset comprises any third subset described herein with respect to FIG. 1 or 3A. In some embodiments, each irradiation position of the third subset is separated from another irradiation position of the third subset by a third predetermined separation distance, as described herein with respect to FIG. 1 or 3A. In some embodiments, the optical scanner is used to apply a second predetermined offset between the third subset and the second subset, as described herein with respect to FIGS. 1 and 3A.

In some embodiments, the method 600 further comprises using the optical scanner is used to receive the pulsed laser light and to scan the pulsed laser light at a fourth predetermined scanning rate to a fourth subset of a plurality of irradiation positions along the line. In some embodiments, the fourth predetermined scanning rate comprises any fourth predetermined scanning rate described herein with respect to FIG. 4A. In some embodiments, the fourth subset comprises any fourth subset described herein with respect to FIG. 1 or 4A. In some embodiments, each irradiation position of the fourth subset is separated from another irradiation position of the fourth subset by the fourth predetermined separation distance, as described herein with respect to FIG. 1 or 4A. In some embodiments, the optical scanner is used to apply a third predetermined offset between the fourth subset and the third subset, as described herein with respect to FIGS. 1 and 4A.

In some embodiments, the method 600 further comprises using the optical scanner to receive the pulsed laser light and to scan the pulsed laser light at fifth, sixth, seventh, eighth, ninth, tenth, or additional predetermined scanning rates to fifth, sixth, seventh, eighth, ninth, tenth, or additional subsets of irradiation positions along the line.

In some embodiments, the method 600 is implemented using any of the systems described herein, such as system 100 described herein with respect to FIG. 1.

In some embodiments, the method 600 is repeated at least about 1 or more times, at most about 10 times, or a number of times than is within a range defined by any two of the preceding values, such as between about 1 time and about 10 times.

In some embodiments, the method 600 is repeated a plurality of times to form a plurality of additively manufactured or 3D printed lines on a layer of an additively manufactured or 3D printed part or component. In some embodiments, the method 600 is repeated a plurality of times to form a plurality of layers of an additively manufactured or 3D printed part or component. In some embodiments, the additively manufactured or 3D printed part or component is formed according to instructions that provide a layer-by-layer processing path.

In some embodiments, the method 600 is repeated a plurality of times to ablate a plurality of lines on a layer of a subtractively manufactured part or component. In some embodiments, the method 600 is repeated a plurality of times to ablate a plurality of layers of a subtractively manufactured part or component. In some embodiments, the subtractively manufactured part or component is ablated according to instructions that provide a layer-by-layer processing path.

In some embodiments, the predetermined scanning rate (such as the first, second, third, or fourth predetermined scanning rate described herein) and the pulse repetition rate determine the predetermined separation distance (such as the first, second, third, or fourth predetermined separation distance described herein) according to Equation (1):

$$s = \frac{r}{p} - D \qquad ( 1 )$$

In Equation (1), s is the predetermined separation distance, r is the predetermined scanning rate, p is the pulse repetition rate, and D is the diameter of the pulsed laser spot. In Equation (1), the predetermined separation distance is measured as the distance between the outer edges of neighboring irradiation positions within a given subset of irradiation positions.

In some embodiments, the predetermined scanning rate (such as the first, second, third, or fourth predetermined scanning rate described herein) and the pulse repetition rate determine the predetermined separation distance (such as the first, second, third, or fourth predetermined separation distance described herein) according to Equation (2):

$$s = \frac{r}{p} \qquad ( 2 )$$

In Equation (2), s is the predetermined separation distance, r is the predetermined scanning rate, and p is the pulse repetition rate. In Equation (2), the predetermined separation distance is measured as the distance between the centers of neighboring irradiation positions within a given subset of irradiation positions.

Additionally, systems are disclosed that can be used to perform the method 600 of FIG. 6, or any of operations 610, 620, and 630 described herein. In some embodiments, the systems comprise one or more processors and memory coupled to the one or more processors. In some embodiments, the one or more processors are configured to implement one or more operations of method 600. In some embodiments, the memory is configured to provide the one or more processors with instructions corresponding to the operations of method 600. In some embodiments, the instructions are embodied in a tangible computer readable storage medium.

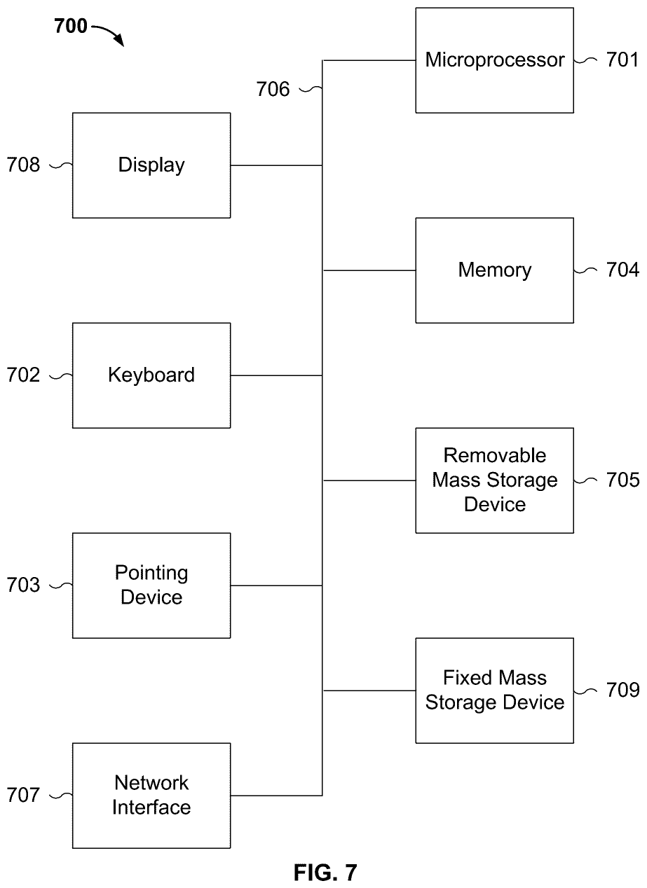

FIG. 7 is a block diagram of a computer system 700 used in some embodiments to perform portions of methods for improved pulsed laser manufacturing described herein (such as any of operation 610, 620, and/or 630 of method 600 as described herein with respect to FIG. 6). In some embodiments, the computer system may be utilized as a component in systems for improved pulsed laser manufacturing described herein. FIG. 7 illustrates one embodiment of a general purpose computer system. Other computer system architectures and configurations can be used for carrying out the processing of the present invention. Computer system 700, made up of various subsystems described below, includes at least one microprocessor subsystem 701. In some embodiments, the microprocessor subsystem comprises at least one central processing unit (CPU) or graphical processing unit (GPU). The microprocessor subsystem can be implemented by a single-chip processor or by multiple processors. In some embodiments, the microprocessor subsystem is a general purpose digital processor which controls the operation of the computer system 700. Using instructions retrieved from memory 704, the microprocessor subsystem controls the reception and manipulation of input data, and the output and display of data on output devices.

The microprocessor subsystem 701 is coupled bi-directionally with memory 704, which can include a first primary storage, typically a random access memory (RAM), and a second primary storage area, typically a read-only memory (ROM). As is well known in the art, primary storage can be used as a general storage area and as scratch-pad memory, and can also be used to store input data and processed data. It can also store programming instructions and data, in the form of data objects and text objects, in addition to other data and instructions for processes operating on microprocessor subsystem. Also as well known in the art, primary storage typically includes basic operating instructions, program code, data and objects used by the microprocessor subsystem to perform its functions. Primary storage devices 704 may include any suitable computer-readable storage media, described below, depending on whether, for example, data access needs to be bi-directional or uni-directional. The microprocessor subsystem 701 can also directly and very rapidly retrieve and store frequently needed data in a cache memory (not shown).

A removable mass storage device 705 provides additional data storage capacity for the computer system 700, and is coupled either bi-directionally (read/write) or uni-directionally (read only) to microprocessor subsystem 701. Storage 705 may also include computer-readable media such as magnetic tape, flash memory, signals embodied on a carrier wave, PC-CARDS, portable mass storage devices, holographic storage devices, and other storage devices. A fixed mass storage 709 can also provide additional data storage capacity. The most common example of mass storage 709 is a hard disk drive. Mass storage 705 and 709 generally store additional programming instructions, data, and the like that typically are not in active use by the processing subsystem. It will be appreciated that the information retained within mass storage 705 and 709 may be incorporated, if needed, in standard fashion as part of primary storage 704 (e.g. RAM) as virtual memory.

In addition to providing processing subsystem 701 access to storage subsystems, bus 706 can be used to provide access other subsystems and devices as well. In the described embodiment, these can include a display monitor 708, a network interface 707, a keyboard 702, and a pointing device 703, as well as an auxiliary input/output device interface, a sound card, speakers, and other subsystems as needed. The pointing device 703 may be a mouse, stylus, track ball, or tablet, and is useful for interacting with a graphical user interface.

The network interface 707 allows the processing subsystem 701 to be coupled to another computer, computer network, or telecommunications network using a network connection as shown. Through the network interface 707, it is contemplated that the processing subsystem 701 might receive information, e.g., data objects or program instructions, from another network, or might output information to another network in the course of performing the above-described method steps. Information, often represented as a sequence of instructions to be executed on a processing subsystem, may be received from and outputted to another network, for example, in the form of a computer data signal embodied in a carrier wave. An interface card or similar device and appropriate software implemented by processing subsystem 701 can be used to connect the computer system 700 to an external network and transfer data according to standard protocols. That is, method embodiments of the present invention may execute solely upon processing subsystem 701, or may be performed across a network such as the Internet, intranet networks, or local area networks, in conjunction with a remote processing subsystem that shares a portion of the processing. Additional mass storage devices (not shown) may also be connected to processing subsystem 701 through network interface 707.

An auxiliary I/O device interface (not shown) can be used in conjunction with computer system 700. The auxiliary I/O device interface can include general and customized interfaces that allow the processing subsystem 701 to send and, more typically, receive data from other devices such as microphones, touch-sensitive displays, transducer card readers, tape readers, voice or handwriting recognizers, biometrics readers, cameras, portable mass storage devices, and other computers.

In addition, embodiments of the present invention further relate to computer storage products with a computer readable medium that contains program code for performing various computer-implemented operations. The computer-readable medium is any data storage device that can store data which can thereafter be read by a computer system. The media and program code may be those specially designed and constructed for the purposes of the present invention, or they may be of the kind well known to those of ordinary skill in the computer software arts. Examples of computer-readable media include, but are not limited to, all the media mentioned above: magnetic media such as hard disks, floppy disks, and magnetic tape; optical media such as CD-ROM disks; magneto-optical media such as floptical disks; and specially configured hardware devices such as application-specific integrated circuits (ASICs), programmable logic devices (PLDs), and ROM and RAM devices. The computer-readable medium can also be distributed as a data signal embodied in a carrier wave over a network of coupled computer systems so that the computer-readable code is stored and executed in a distributed fashion. Examples of program code include both machine code, as produced, for example, by a compiler, or files containing higher level code that may be executed using an interpreter. The computer system shown in FIG. 7 is but an example of a computer system suitable for use with the invention. Other computer systems suitable for use with the invention may include additional or fewer subsystems. In addition, bus 706 is illustrative of any interconnection scheme serving to link the subsystems. Other computer architectures having different configurations of subsystems may also be utilized.

### RECITATION OF EMBODIMENTS

Embodiment 1. A system comprising:
a pulsed laser source configured to emit pulsed laser light;
an optical scanner configured to receive the pulsed laser light and to scan the pulsed laser light along a line of a surface, the line comprising a plurality of irradiation positions; and
a controller coupled to the optical scanner, the controller configured to:
   direct the optical scanner to scan the pulsed laser light along the line at a first predetermined scanning rate to a first subset of the plurality of irradiation positions, each irradiation position of the first subset separated from another irradiation position of the first subset by a first predetermined separation distance; and
   direct the optical scanner to scan the pulsed laser light along the line at a second predetermined scanning rate to a second subset of the plurality of irradiation positions, each irradiation position of the second subset separated from another irradiation position of the second subset by a second predetermined separation distance;
   wherein the first subset is different from the second subset.

Embodiment 2. The system of Embodiment 1, wherein the controller is further configured to direct the optical scanner to apply a first predetermined offset distance between the second subset and the first subset.

Embodiment 3. The system of Embodiment 1 or 2, wherein each irradiation position of the first subset along the line is different from each irradiation position of the second subset along the line.

Embodiment 4. The system of any one of Embodiments 1-3, wherein the controller is further configured to direct the optical scanner to scan the pulsed laser light along the line at a third predetermined scanning rate to a third subset of the plurality of irradiation positions, each irradiation position of the third subset separated from another irradiation position of the third subset by a third predetermined separation distance; wherein the third subset is different from the first subset and the second subset.

Embodiment 5. The system of Embodiment 4, wherein the controller is further configured to direct the optical scanner to apply a second predetermined offset distance between the third subset and the second subset.

Embodiment 6. The system of any one of Embodiments 1-5, wherein the controller is further configured to direct the optical scanner to scan the pulsed laser light along the line at a fourth predetermined scanning rate to a fourth subset of the plurality of irradiation positions, each irradiation position of the fourth subset separated from another irradiation position of the fourth subset by a fourth predetermined separation distance; wherein the fourth subset is different from the first subset, the second subset, and the third subset.

Embodiment 7. The system of Embodiment 6, wherein the controller is further configured to direct the optical scanner to apply a third predetermined offset distance between the fourth subset and the third subset.

Embodiment 8. The system of any one of Embodiments 1-7, wherein the optical scanner comprises a galvanometer.

Embodiment 9. The system of Embodiment 8, wherein the controller is configured to direct the galvanometer to scan the pulsed laser light along the line at the first, second, third, or fourth predetermined scanning rate by supplying a time-varying voltage to the galvanometer.

Embodiment 10. The system of Embodiment 8 or 9, wherein the controller is configured to direct the galvanometer to apply the first, second, or third predetermined offset distance by supplying an offset voltage to the galvanometer.

Embodiment 11. The system of any one of Embodiments 1-7, wherein the optical scanner comprises a planar mirror and a rotating polygon mirror.

Embodiment 12. The system of Embodiment 11, wherein the controller is configured to direct the rotating polygon mirror to scan the pulsed laser light along the line at the first, second, third, or fourth predetermined scanning rate by supplying a continuous voltage to the rotating polygon mirror.

Embodiment 13. The system of Embodiment 11 or 12, wherein the controller is configured to direct the planar mirror to apply the first, second, or third predetermined offset distance by rotating the planar mirror.

Embodiment 14. The system of any one of Embodiments 1-13, wherein the pulsed laser light comprises a plurality of laser pulses emitted at a pulse repetition rate and wherein the first, second, third, or fourth predetermined separation distance is determined based upon the first, second, third, or fourth predetermined scanning rate and the pulse repetition rate.

Embodiment 15. The system of any one of Embodiments 1-14, wherein the first, second, third, or fourth predetermined separation distance is chosen such that a pulsed laser light energy delivered to each irradiation position is reduced from a pulsed light energy supplied by the pulsed laser source by no more than 50%.

Embodiment 16. The system of any one of Embodiments 1-15, wherein the first, second, third, or fourth predetermined separation distance is at least about 1 micrometer (μm).

Embodiment 17. The system of any one of Embodiments 1-16, wherein a ratio of the first, second, third, or fourth predetermined separation distance to a diameter of the pulsed laser light is at least about 0.5.

Embodiment 18. The system of any one of Embodiments 1-17, wherein the first, second, third, or fourth predetermined scanning rate is at least about 1 meter per second (m/s).

Embodiment 19. A method comprising:
using a pulsed laser source to emit pulsed laser light;
using an optical scanner to receive the pulsed laser light and to scan the pulsed laser light at a first predetermined scanning rate to a first subset of a plurality of irradiation positions located along a line of a surface, each irradiation position of the first subset separated from another irradiation position of the first subset by a first predetermined separation distance; and
using the optical scanner to scan the pulsed laser light along the line at a second predetermined scanning rate to a second subset of the plurality of irradiation positions, each irradiation position of the second subset separated from another irradiation position of the second subset by a second predetermined separation distance;
wherein the first subset is different from the second subset.

Embodiment 20. The method of Embodiment 19, further comprising using the optical scanner to apply a first predetermined offset distance between the second subset and the first subset.

Embodiment 21. The method of Embodiment 19 or 20, wherein each irradiation position of the first subset along the line is different from each irradiation position of the second subset along the line.

Embodiment 22. The method of any one of Embodiments 19-21, further comprising using the optical scanner to scan the pulsed laser light along the line at a third predetermined scanning rate to a third subset of the plurality of irradiation positions, each irradiation position of the third subset separated from another irradiation position of the third subset by a third predetermined separation distance; wherein the third subset is different from the first subset and the second subset.

Embodiment 23. The method of Embodiment 22, further comprising using the optical scanner to apply a second predetermined offset distance between the third subset and the second subset.

Embodiment 24. The method of any one of Embodiments 19-23, further comprising using the optical scanner to scan the pulsed laser light along the line at a fourth predetermined scanning rate to a fourth subset of the plurality of irradiation positions, each irradiation position of the fourth subset separated from another irradiation position of the fourth subset by a fourth predetermined separation distance; wherein the fourth subset is different from the first subset, the second subset, and the third subset.

Embodiment 25. The method of Embodiment 24, further comprising using the optical scanner to apply a third predetermined offset distance between the fourth subset and the third subset.

Embodiment 26. The method of any one of Embodiments 19-25, wherein the optical scanner comprises a galvanometer.

Embodiment 27. The method of Embodiment 26, further comprising using the galvanometer to scan the pulsed laser light along the line at the first, second, third, or fourth predetermined scanning rate by supplying a time-varying voltage to the galvanometer.

Embodiment 28. The method of Embodiment 26 or 27, further comprising using the galvanometer to apply the first, second, or third predetermined offset distance by supplying an offset voltage to the galvanometer.

Embodiment 29. The method of any one of Embodiments 19-25, wherein the optical scanner comprises a planar mirror and a rotating polygon mirror.

Embodiment 30. The method of Embodiment 29, further comprising using the rotating polygon mirror to scan the pulsed laser light along the line at the first, second, third, or fourth predetermined scanning rate by supplying a continuous voltage to the rotating polygon mirror.

Embodiment 31. The method of Embodiment 29 or 30, further comprising using the planar mirror to apply the first, second, or third predetermined offset distance by rotating the planar mirror.

Embodiment 32. The method of any one of Embodiments 19-31, wherein the pulsed laser light comprises a plurality of laser pulses emitted at a pulse repetition rate and wherein the first, second, third, or fourth predetermined separation distance is determined based upon the first, second, third, or fourth predetermined scanning rate and the pulse repetition rate.

Embodiment 33. The method of any one of Embodiments 19-32, wherein the first, second, third, or fourth predetermined separation distance is chosen such that a pulsed laser light energy delivered to each irradiation position is reduced from a pulsed light energy supplied by the pulsed laser by no more than 50%

Embodiment 34. The method of any one of Embodiments 19-33, wherein the first, second, third, or fourth predetermined separation distance is at least about 1 micrometer (μm).

Embodiment 35. The method of any one of Embodiments 19-34, wherein a ratio of the first, second, third, or fourth predetermined separation distance to a diameter of the pulsed laser light is at least about 0.5.

Embodiment 36. The method of any one of Embodiments 19-35, wherein the first, second, third, or fourth predetermined scanning rate is at least about 1 meter per second (m/s).

1-36. (canceled)

37. A system comprising:
a pulsed laser source configured to emit pulsed laser light;
an optical scanner configured to receive the pulsed laser light and to scan the pulsed laser light along a line of a surface of an object, the line comprising a plurality of irradiation positions; and
a controller coupled to the optical scanner,
the controller configured to:
direct the optical scanner to scan the pulsed laser light along the line at a first predetermined scanning rate to a first subset of the plurality of irradiation positions, each irradiation position of the first subset separated from another by a first predetermined interval;
direct the optical scanner to scan the pulsed laser light along the line at a second predetermined scanning rate to a second subset, which is different from the first subset, of the plurality of irradiation positions, each irradiation position of the second subset separated from another by a second predetermined interval; and
remove a part of the object by irradiating the pulsed laser light to the plurality of irradiation positions,
wherein each of the plurality of irradiation positions of the second subset is located between the plurality of irradiation positions of the first subset.

38. The system of claim 37, wherein irradiation areas on the surface of the pulsed laser light irradiated to the plurality of irradiation positions of the first subset and irradiation areas on the surface of the pulsed laser light irradiated to the plurality of irradiation positions of the second subset do not overlap with each other.

39. The system of claim 37, wherein irradiation areas on the surface of the pulsed laser light irradiated to the plurality of irradiation positions of the first subset and irradiation areas on the surface of the pulsed laser light irradiated to the plurality of irradiation positions of the second subset partially overlap.

40. The system of claim 39, wherein the irradiation area is defined by a full width at half maximum of the pulsed laser light.

41. The system of claim 38, wherein the irradiation area is defined by a full width at half maximum of the pulsed laser light.

42. The system of claim 37, wherein the pulsed laser source comprises a femtosecond laser light source.

43. The system of claim 37, wherein an offset distance which is a distance between the irradiation position of the first subset and the irradiation position of the second subset, is greater than or equal to at least 1 μm.

44. The system of claim 37, wherein a ratio of at least one interval of the first predetermined interval and the second predetermined interval to a diameter of the pulsed laser light is at least 0.5.

45. The system of claim 37, wherein the controller is further configured to direct the optical scanner to apply a first predetermined offset distance between the second subset and the first subset.

46. The system of claim 37, wherein each irradiation position of the first subset along the line is different from each irradiation position of the second subset along the line.

47. The system of claim 37, wherein the controller is further configured to direct the optical scanner to scan the pulsed laser light along the line at a third predetermined scanning rate to a third subset of the plurality of irradiation positions, each irradiation position of the third subset separated from another irradiation position of the third subset by a third predetermined separation distance; wherein the third subset is different from the first subset and the second subset.

48. The system of claim 47, wherein the controller is further configured to direct the optical scanner to apply a second predetermined offset distance between the third subset and the second subset.

49. The system of claim 37, wherein the controller is further configured to direct the optical scanner to scan the pulsed laser light along the line at a fourth predetermined scanning rate to a fourth subset of the plurality of irradiation positions, each irradiation position of the fourth subset separated from another irradiation position of the fourth subset by a fourth predetermined separation distance; wherein the fourth subset is different from the first subset, the second subset, and the third subset.

50. The system of claim 49, wherein the controller is further configured to direct the optical scanner to apply a third predetermined offset distance between the fourth subset and the third subset.

51. The system of claim 37, wherein the optical scanner comprises a galvanometer.

52. The system of claim 51, wherein the controller is configured to direct the galvanometer to scan the pulsed laser light along the line at the first, second, third, or fourth predetermined scanning rate by supplying a time-varying voltage to the galvanometer.

53. The system of claim 51, wherein the controller is configured to direct the galvanometer to apply the first, second, or third predetermined offset distance by supplying an offset voltage to the galvanometer.

54. The system of claim 37, wherein the optical scanner comprises a planar mirror and a rotating polygon mirror.

55. A system comprising:
a pulsed laser source configured to emit pulsed laser light;
an optical scanner configured to receive the pulsed laser light and to scan the pulsed laser light along a line of a surface, the line comprising a plurality of irradiation positions; and
a controller coupled to the optical scanner and configured to direct the optical scanner,
wherein the optical scanner comprises a planer mirror and a rotating polygon mirror, the planer mirror is located on an optical path of the pulsed laser light and is rotated by the controller, the rotating polygon mirror is located on the optical path of the pulsed laser light.

56. The system of claim 54, wherein the controller is configured to direct the rotating polygon mirror to scan the pulsed laser light along the line at the first, second, third, or fourth predetermined scanning rate by supplying a continuous voltage to the rotating polygon mirror.

57. The system of claim 54, wherein the controller is configured to direct the planar mirror to apply the first, second, or third predetermined offset distance by rotating the planar mirror.

58. The system of claim 37, wherein the pulsed laser light comprises a plurality of laser pulses emitted at a pulse repetition rate and wherein the first, second, third, or fourth predetermined separation distance is determined based upon the first, second, third, or fourth predetermined scanning rate and the pulse repetition rate.

59. The system of claim 37, wherein the first, second, third, or fourth predetermined separation distance is chosen such that a pulsed laser light energy delivered to each irradiation position is reduced from a pulsed light energy supplied by the pulsed laser source by no more than 50%.

60. The system of claim 37, wherein the first, second, third, or fourth predetermined separation distance is at least about 1 micrometer (μm).

61. The system of claim 37, wherein a ratio of the first, second, third, or fourth predetermined separation distance to a diameter of the pulsed laser light is at least about 0.5.

62. The system of claim 37, wherein the first, second, third, or fourth predetermined scanning rate is at least about 1 meter per second (m/s).

63. A system comprising:
a pulsed laser source configured to emit pulsed laser light;
an optical scanner configured to receive the pulsed laser light and to scan the pulsed laser light along a line of a surface, the line comprising a plurality of irradiation positions; and
a controller coupled to the optical scanner, the controller configured to:
direct the optical scanner to scan the pulsed laser light along the line at a first predetermined scanning rate to a first subset of the plurality of irradiation positions, each irradiation position of the first subset separated from another irradiation position of the first subset by a first predetermined separation distance; and
direct the optical scanner to scan the pulsed laser light along the line at a second predetermined scanning rate to a second subset of the plurality of irradiation positions, each irradiation position of the second subset separated from another irradiation position of the second subset by a second predetermined separation distance;
wherein the first subset is different from the second subset.

64. A method for irradiating the pulsed laser light toward a surface of an object by using the system of claim 63 thereby removing at least a part of the surface.

65. A method for irradiating the pulsed laser light toward a surface of an object by using the system of claim 37 thereby removing at least a part of the surface.

66. The system of claim 37, wherein an influence of plasma generated when the pulsed laser light is irradiated to one irradiation position of two adjacent irradiation positions among the plurality of irradiation positions in the first subset does not affect the pulsed laser light irradiated to the other irradiation position of the two adjacent irradiation positions.
